(19) United States
(12) Patent Application Publication
(10) Pub. No.: US 2018/0260888 A1
(43) Pub. Date: Sep. 13, 2018

(54) Validating Mortgage Documents

(71) Applicant: Factom, Austin, TX (US)

(72) Inventors: Mahesh Paolini-Subramanya, Austin, TX (US); Jason Nadeau, Missouri City, TX (US); Brian Deery, Austin, TX (US); Paul Snow, Austin, TX (US)

(21) Appl. No.: 15/452,760

(22) Filed: Mar. 8, 2017

(51) Int. Cl. G06Q 40/02; G06Q 20/40; H04L 9/32; H04L 9/06

(52) U.S. Cl. CPC G06Q 40/025; G06Q 20/4016; H04L 9/0637; H04L 9/0643; H04L 9/3247

(57) ABSTRACT

Authentication of mortgage documents is based on one or more digital signatures incorporated into a blockchain. Structured data, metadata, and instructions may be hashed to generate the multiple digital signatures for distribution via the blockchain. Any peer receiving the blockchain may then verify an authenticity of the mortgage documents based on the digital signature(s) incorporated into the blockchain.

### CROSS-REFERENCE TO RELATED APPLICATIONS

This application relates to U.S. application Ser. No. 15/419,033 filed Jan. 30, 2017, to U.S. application Ser. No. 15/419,042 filed Jan. 30, 2017, and to U.S. application Ser. No. 15/435,612 filed Feb. 17, 2017, with all applications incorporated herein by reference in their entireties.

### BACKGROUND

The mortgage industry has learned from the past. The so-called mortgage crisis of 2007 exposed flaws in the mortgage industry. Many mortgages lacked sufficient documentation, checks and balances were not implemented, and fraud was alleged.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIGS. 1-6 are simplified illustrations of validating mortgage documents, according to exemplary embodiments;

FIGS. 7-10 are detailed illustrations of an operating environment, according to exemplary embodiments;

FIGS. 11-15 further illustrate verification, according to exemplary embodiments;

FIG. 16 illustrates multiple digital signatures, according to exemplary embodiments;

FIG. 17 illustrates a blockchain, according to exemplary embodiments;

FIG. 18 illustrates multiple verifications, according to exemplary embodiments;

FIG. 19 illustrates multiple blockchains, according to exemplary embodiments;

FIGS. 20-22 further illustrate verification of absence, according to exemplary embodiments;

FIGS. 23-24 illustrate sequential verification, according to exemplary embodiments; and

FIGS. 25-26 depict still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

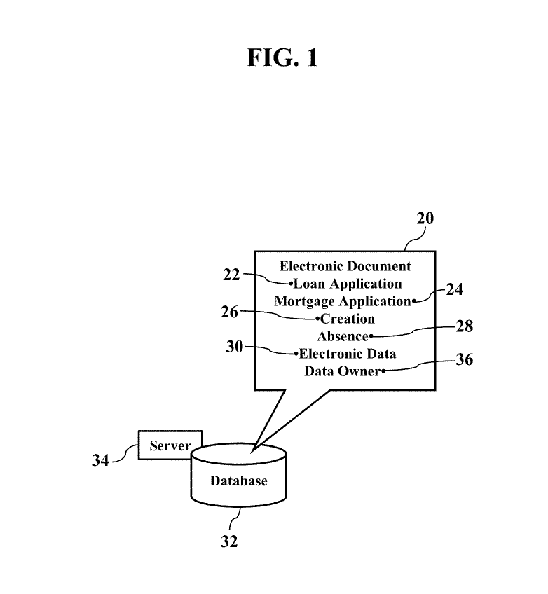

FIGS. 1-6 are simplified illustrations of validating mortgage documents, according to exemplary embodiments. FIG. 1 illustrates an electronic document 20 that is a part or a component of loan application 22. Indeed, many readers are likely familiar with an electronic mortgage application 24 that is processed when financing a mortgage for a home or business property. The electronic document 20, however, may be associated with any other type of loan, such as a vehicle installment, business or equipment purchase, and even equity lines of credit. Regardless, exemplary embodiments determine whether the electronic document 20 has been altered since its creation 26. As the reader may understand, if the electronic document 20 has changed since its original creation 26, then perhaps the loan application 22 deserves extra scrutiny. That is, perhaps malicious or fraudulent activity has been detected in the electronic mortgage application 24. Indeed, exemplary embodiments may even verify an absence 28 of the electronic document 20 within the loan application 22, perhaps further indicating fraud.

The electronic document 20 is securely stored. When the loan application 22 (e.g., the electronic mortgage application 24) is created (at a date and time of creation 26), the corresponding electronic data 30 may be stored to an electronic database 32. That is, the electronic data 30 representing the electronic mortgage application 24 may be stored to a server 34 operated by, or on behalf of, a data owner 36. Again, as most readers understand, the data owner 36 is typically a financial lending institution (such as WELLS FARGO® or BANK OF AMERICA®) offering, evaluating, and/or processing the loan application 22. The actual electronic data 30 representing the electronic mortgage application 24 may thus be securely stored in the electronic database 32 for retrieval by trusted users, vendors, suppliers, and/or sub-contractors.

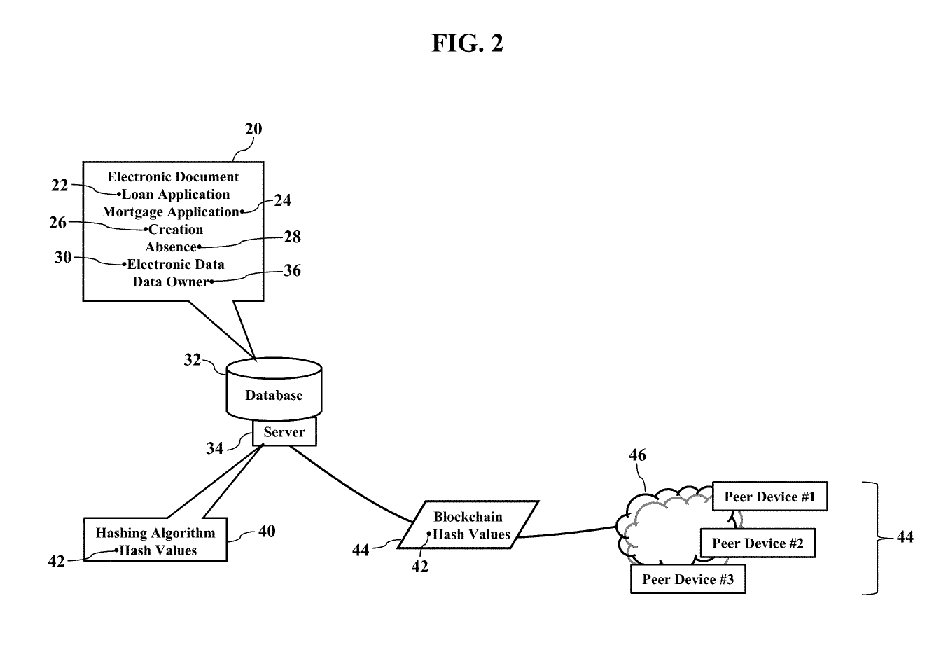

FIG. 2 illustrates secure distribution. Once the electronic document 20 is packaged with the loan application 22, the corresponding electronic data 30 may be hashed using a hashing algorithm 40. The resulting hash value(s) 42 may then be distributed via one or more blockchains 42 to one or more trusted peer devices 44. That is, the hash value 42 may be incorporated into the block chain(s) 42 and distributed via a communications network 46 to the trusted peer devices 44. Each trusted peer device 44 may thus receive the hash value(s) 42 incorporated into the blockchain 42.

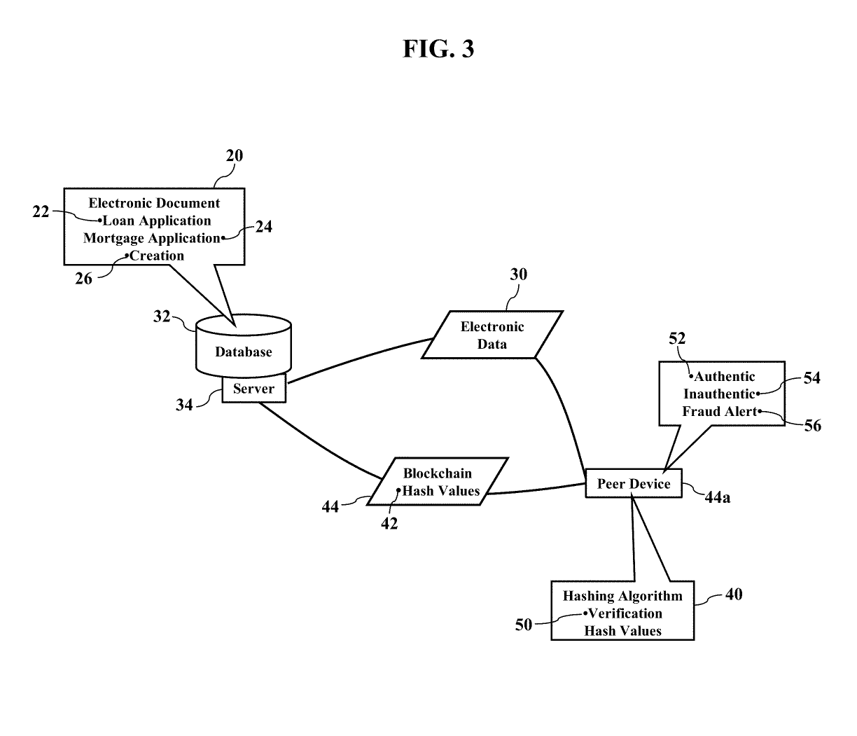

FIG. 3 illustrates a validation scheme. Now that the hash values 42 have been distributed (via the blockchain 42), any one of the trusted peer devices 44 may validate the loan application 22. A trusted peer device 44a, for example, may query the server 34 storing the electronic database 32 and retrieve the electronic data 30 representing the electronic document 20 and/or the entire mortgage application 24. The trusted peer device 44 may hash the electronic data 30 using the hashing algorithm 40 to generate verification hash values 50. The trusted peer device 44 may then compare the verification hash values 50 to the hash values 42 previously received via the blockchain 42. If a match is determined, then the trusted peer device 44 may infer that the electronic mortgage application 24 (retrieved from the server 34) is authentic 52. That is, the electronic data 30 is unchanged since the date and time of the creation 26. However, if the verification hash values 50 fail to match the hash values 42 previously received via the blockchain 42, then the electronic mortgage application 24 may be inauthentic 54. The electronic data 30, in other words, may have changed and/or altered since the creation 26. The trusted peer device 44 may thus generate a fraud alert 56 to implement enhanced security measures.

Exemplary embodiments thus include third party validation. At any time, the trusted peer device 44 may verify the authenticity of the electronic data 30 retrieved from the electronic database 32. If hashing of the electronic data 30 yields a different result from the blockchain 42, then the loan application 22 has been unintentionally, intentionally, or even maliciously altered since the creation 26. This disclosure need not speculate on why the electronic data 30 was changed. Suffice it to say that the trusted peer device 44 may merely generate the fraud alert 56 to escalate further investigation. The trusted peer device 44 may thus be operated on behalf of a third-party vendor, supplier, sub-contractor, or even a governmental entity. Exemplary embodiments, in plain words, permit simple and quick oversight of mortgage documentation.

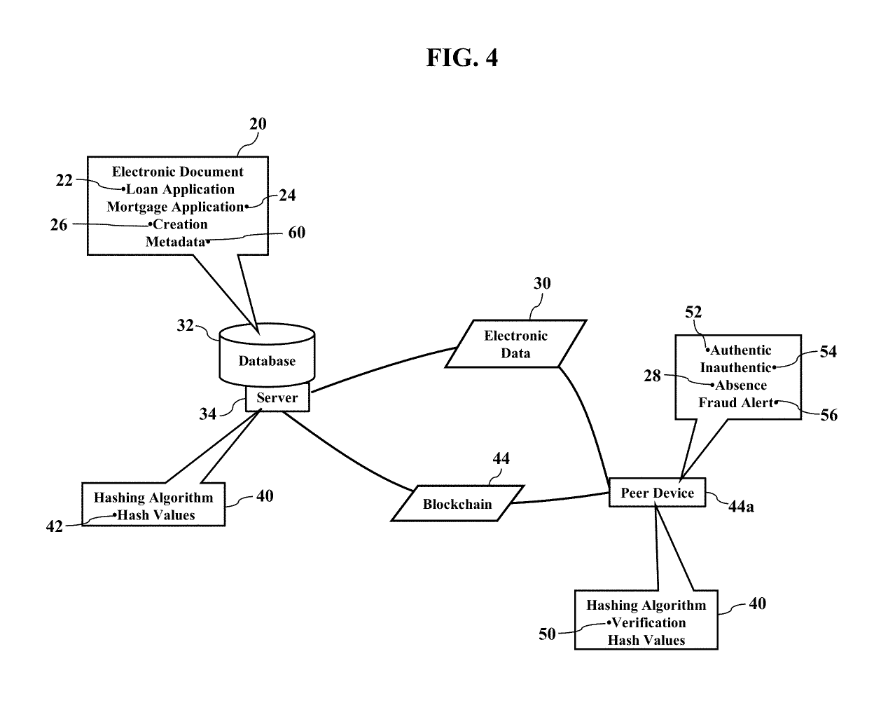

FIGS. 4-6 illustrate verification of the absence 28. Here exemplary embodiments may even verify the absence 28 of the electronic document 20 within the loan application 22, perhaps further indicating fraud. When the blockchain 42 is received, the blockchain 42 may additionally include the hash values 42 calculated using metadata 60 associated with the electronic document 20 and/or the loan application 22. The metadata 60 may or may not be hashed (using the hashing algorithm 40) and integrated within the blockchain 42 for distribution. When the trusted peer device 44 receives the blockchain 42, the trusted peer device 44 may then verify whether the server 34 still retains the same metadata 60. If the metadata 60 (retrieved from the electronic database 32) fails to match the blockchain 42, then the electronic document 20 and/or the loan application 22 may be inauthentic 54 and the fraud alert 56 is generated.

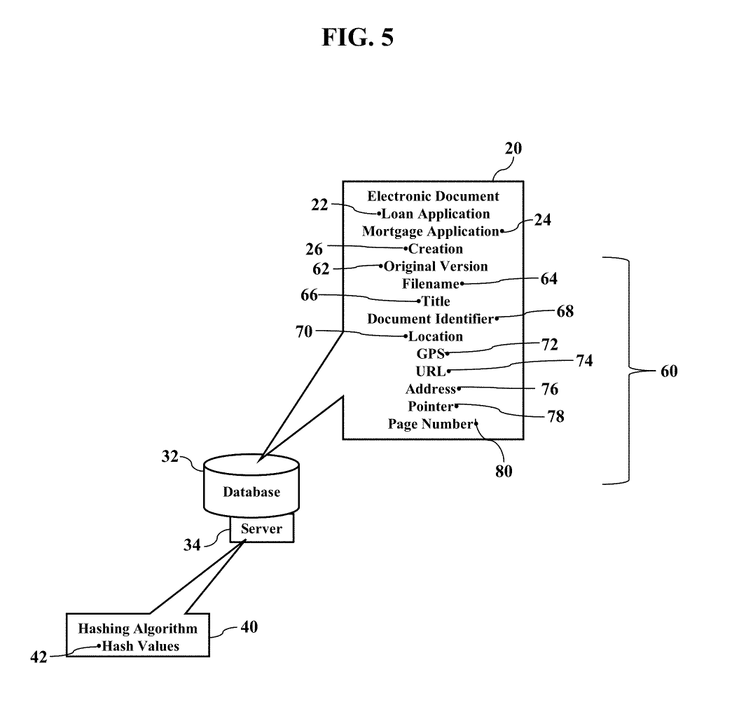

FIG. 5 illustrates some of the metadata 60. For example, the metadata 60 may specify a version number (such as an original version 62 at the creation 26) of the electronic document 20 that is contained within the loan application 22. The metadata 60 may additionally or alternatively specify a filename 64, a title 66, or other document identifier 68 associated with the electronic document 20. The metadata 60 may also specify a location 70 associated with the electronic document 20. The location 70 may be a geographical location (such as global positioning system coordinates 72) and/or a logical location (such as a uniform resource locator (or URL”) 74, a network address 76, a memory pointer 78, or even a page number 80 within the loan application 22). Whatever the metadata 60, exemplary embodiments may or may not hash the metadata 60 (using the hashing algorithm 40) and integrate within the blockchain 42.

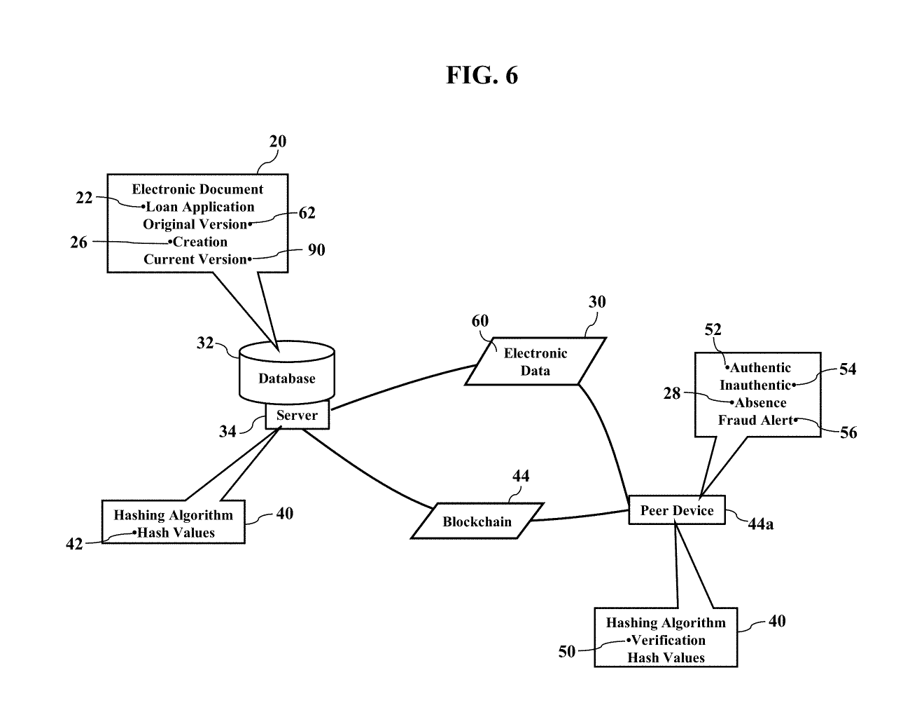

FIG. 6 illustrates the verification. When the trusted peer device 44 receives the blockchain 42, the trusted peer device 44 may then verify whether the server 34 still retains the same metadata 60. The trusted peer device 44a retrieves a current version 90 of the electronic data 30 from the electronic database 32. The current version 90 of the electronic data 30 may be hashed to yield the verification hash values 50. The trusted peer device 44a may then compare the verification hash values 50 (generated from the metadata 60 associated with the current version 90 of the electronic data 30) to the hash values 42 integrated within the blockchain 42. If a match is determined, then the current version 90 matches the original version 62 saved at the creation 26. However, if the current version 90 differs from the original version 62 specified by the blockchain 42, then the metadata 60 has changed. For example, if the hashed metadata 60 describing the location 70 has changed, then the electronic document 20 has been accessed or saved at a different geographical or logical location. Indeed, bit differences between the verification hash values 50 and the hash values 42 may reveal that the electronic document 20 has moved to a different uniform resource locator, network address, and/or memory location or device. Even changes to page numbering may be discerned. The absence 28 has thus been determined, perhaps causing the trusted peer device 44 to generate the fraud alert 56 to initiate a fraud investigation. Again, then, third-party entities may perform automated oversight of mortgage documentation.

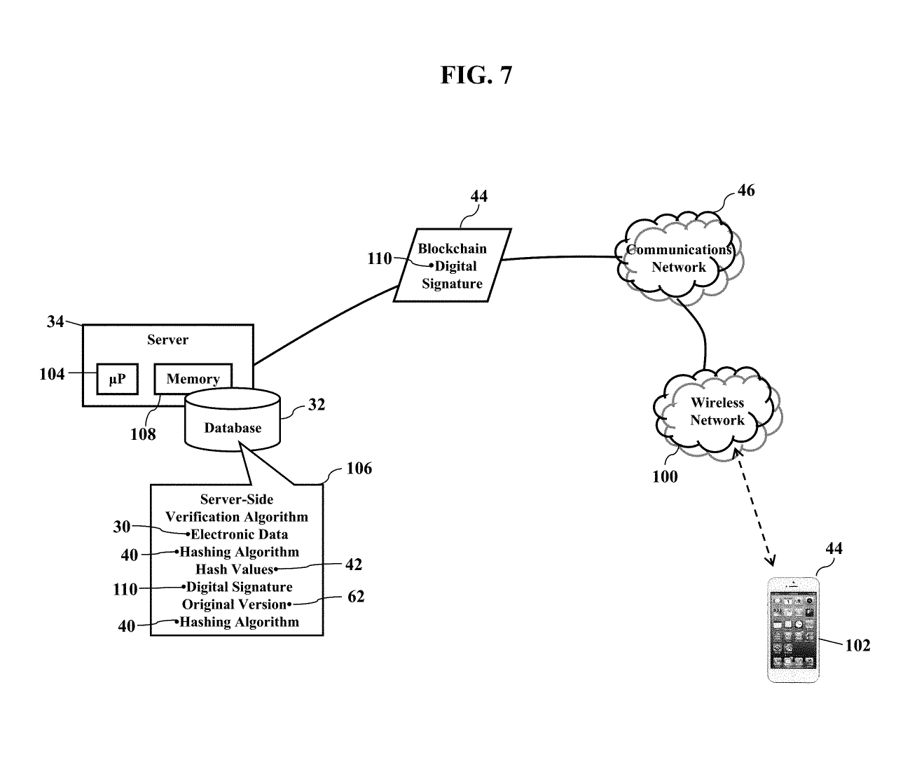

FIGS. 7-10 are detailed illustrations of an operating environment, according to exemplary embodiments. FIG. 7 illustrates the server 34 communicating with the trusted peer device 44 via the communications network 46 (and perhaps a wireless network 100). FIG. 7 illustrates the trusted peer device 44 as a mobile smartphone 102, which most readers are thought familiar. The trusted peer device 44, though, may be any processor-controlled device, as later paragraphs will explain. The server 34 may have a processor 104 (e.g., “μP”), application specific integrated circuit (ASIC), or other component that executes a server-side verification algorithm 106 stored in a local memory device 108. The server-side verification algorithm 106 includes instructions, code, and/or programs that cause the server 34 to perform operations, such as hashing the electronic data 30 using the hashing algorithm 40 to generate the hash values 42 (as the above paragraphs explained). The hash values 42 thus represent a digital signature 110 representing the original version 62. The server-side verification algorithm 106 may then instruct or cause the server 34 to integrate the digital signature 110 into the blockchain 42 for distribution to the mobile smartphone 102. Exemplary embodiments, though, may send the digital signature 110 and/or the blockchain 42 to any IP address associated with any network destination or device.

Exemplary embodiments may use any hashing function. Many readers may be familiar with the SHA-256 hashing algorithm that generates a 256-bit hash value. Exemplary embodiments obtain or retrieve the electronic data 30 representing the original version 62 of the electronic document 20. The electronic data 30 is acted on by the SHA-256 hashing algorithm to generate a 256-bit hash value as the digital signature 110. There are many hashing algorithms, though, and exemplary embodiments may be adapted to any hashing algorithm.

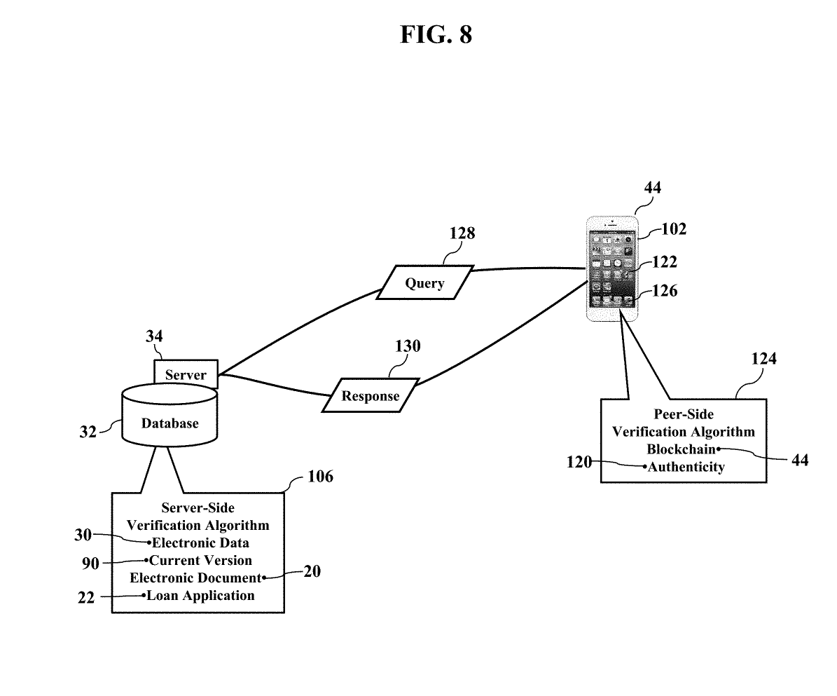

FIG. 8 illustrates document retrieval. Now that the blockchain 42 is distributed, the trusted peer device 44 (again illustrated as the mobile smartphone 102) may determine an authenticity 120 of the current version 90 of the electronic data 30 stored by the server 34. The mobile smartphone 102 has a processor 122, application specific integrated circuit (ASIC), or other component that executes a peer-side verification algorithm 124 stored in a local memory device 126. The peer-side verification algorithm 124 includes instructions, code, and/or programs that cause the processor 122 to perform operations, such as retrieving the current version 90 of the electronic document 20 (or the entire loan application 22) stored by the server 34. The peer-side verification algorithm 124 causes the mobile smartphone 102 to generate a query 128 specifying the electronic document 20 or even the entire loan application 22. The query 128 is sent to the network address (e.g., Internet Protocol address) associated with the server 34. When the server 34 receives the query 128, the server-side verification algorithm 106 instructs the server 34 to retrieve the current version 90 of the electronic document 20 (or the entire loan application 22) from the electronic database 32. The server-side verification algorithm 106 causes the server 34 to generate and send a query response 130 including the electronic data 30 representing current version 90. The query response 130 routes along the communications network 46 (illustrated in FIG. 7) to the network address associated with the mobile smartphone 102.

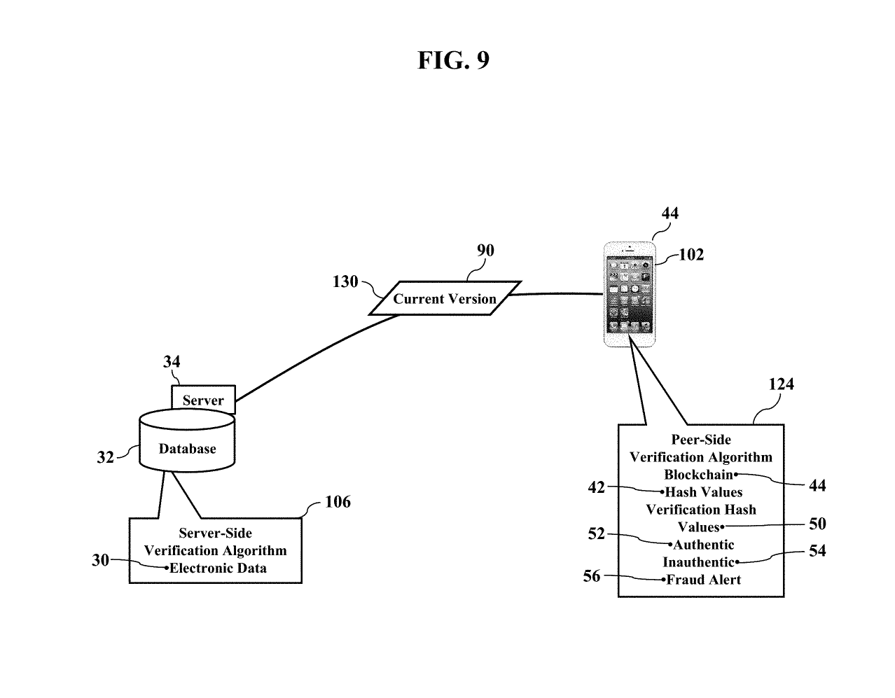

FIG. 9 illustrates verification. When the query response 130 is received, the trusted peer device 44 may verify against the blockchain 42. The peer-side verification algorithm 124 causes the mobile smartphone 102 to retrieve the electronic data 30 representing the current version 90 and to generate the verification hash values 50 (such as the corresponding 256-bit hash). If the verification hash values 50 satisfactorily compare to the hash values 42 received via the blockchain 42, then the peer-side verification algorithm 124 may infer or determine that the current version 60 is authentic 52 and unaltered. However, if the verification hash values 50 fail to satisfy the hash values 42 received via the blockchain 42, then the peer-side verification algorithm 124 may infer that the current version 60 is inauthentic 54 and altered. The peer-side verification algorithm 124 may thus generate the fraud alert 56 to implement enhanced security measures.

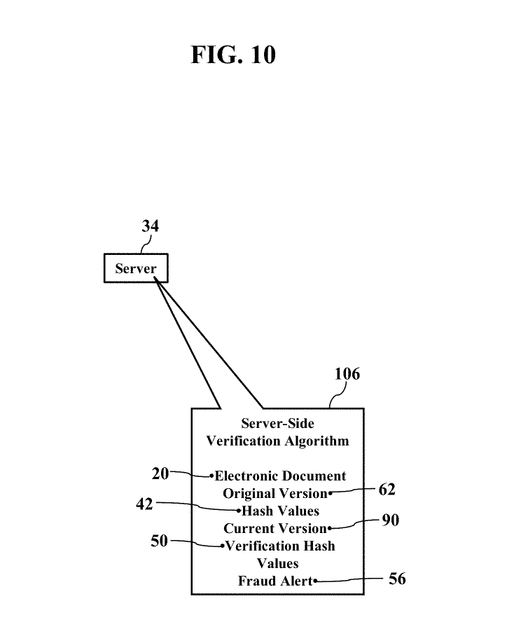

FIG. 10 illustrates servile verification. Here the server 34 may itself determine the authenticity of the electronic document 20. Whenever the server 34 receives the current version 90 of the electronic document 20, the server 34 may alert or notify of security concerns. Here the server-side verification algorithm 106 causes the server 34 to retrieve the current version 90 and to generate the corresponding verification hash values 50. If the verification hash values 50 satisfactorily compare to the hash values 42 (representing the original version 62), then the server-side verification algorithm 106 may infer or determine that the current version 90 is authentic and unaltered. However, if the verification hash values 50 fail to satisfy the hash values 42 (representing the original version 62), then the server-side verification algorithm 106 may implement the fraud alert 56, as the current version 90 is inauthentic and/or altered.

Exemplary embodiments may be applied regardless of networking environment. Exemplary embodiments may be easily adapted to stationary or mobile devices having cellular, wireless fidelity (WI-FI®), near field, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform “operations”, this could include the processor performing the operations directly and/or facilitating, directing, or cooperating with another device or component to perform the operations.

Exemplary embodiments may packetize. The server 34 and the trusted peer device 44 may have network interfaces to the communications network 46, thus allowing collection and retrieval of information. The information may be received as packets of data according to a packet protocol (such as the Internet Protocol). The packets of data contain bits or bytes of data describing the contents, or payload, of a message. A header of each packet of data may contain routing information identifying an origination address and/or a destination address associated with any of the server 34 and the trusted peer device 44.

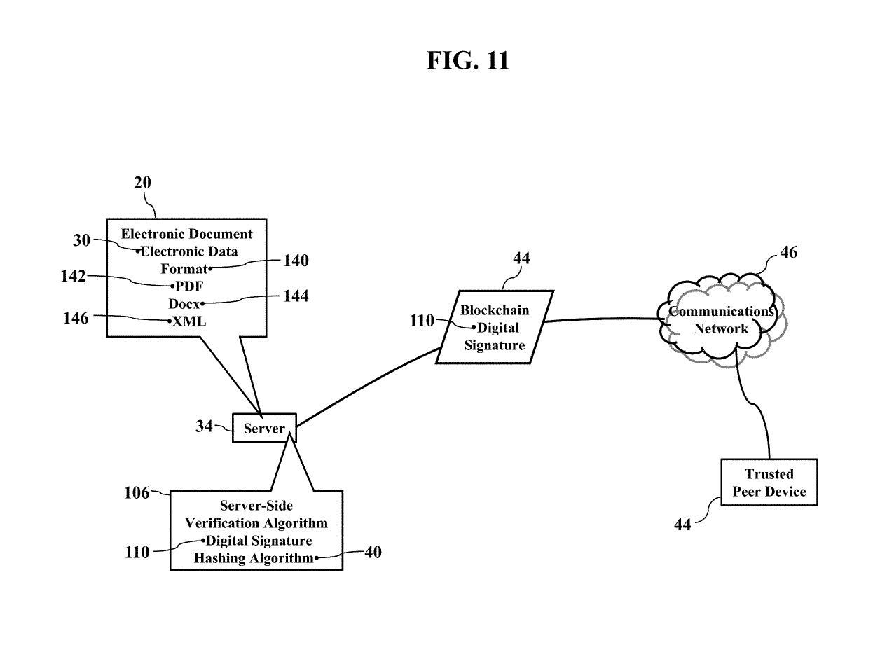

FIGS. 11-15 further illustrate verification, according to exemplary embodiments. Here exemplary embodiments may verify the authenticity of the electronic document 20, based on its electronic data 30. The electronic data 30 is typically formatted according to one or more formats 140. Most readers, for example, are thought familiar with a portable document format (“PDF”) 142, the MICROSOFT® WORD® extensible markup language extension (“docx”) 144, and/or the extensible markup language (“XML”) 146. Exemplary embodiments may thus retrieve the electronic data 30 representing the electronic document 20 (and/or the entire loan application 22 explained herein) and generate the corresponding digital signature 110 (such as the corresponding 256-bit hash if using the SHA-256 hashing algorithm 40). Exemplary embodiments may then incorporate the digital signature 110 into the blockchain 42 for distribution via the communications network 46. Any destination (such as the trusted peer device 44) may thus verify an alleged copy of the electronic document 20 against the blockchain 42 (as this disclosure above explains).

Exemplary embodiments may be applied to any file formatting and/or specification. The format 140 may be proprietary, free, unpublished, and/or open. The format 140 may be designed for images, containers, audio, video, text, subtitles, control characters, and encoding schemes. The format 140 may be HTML, vector graphics, source code, text files, syntax, and software programming.

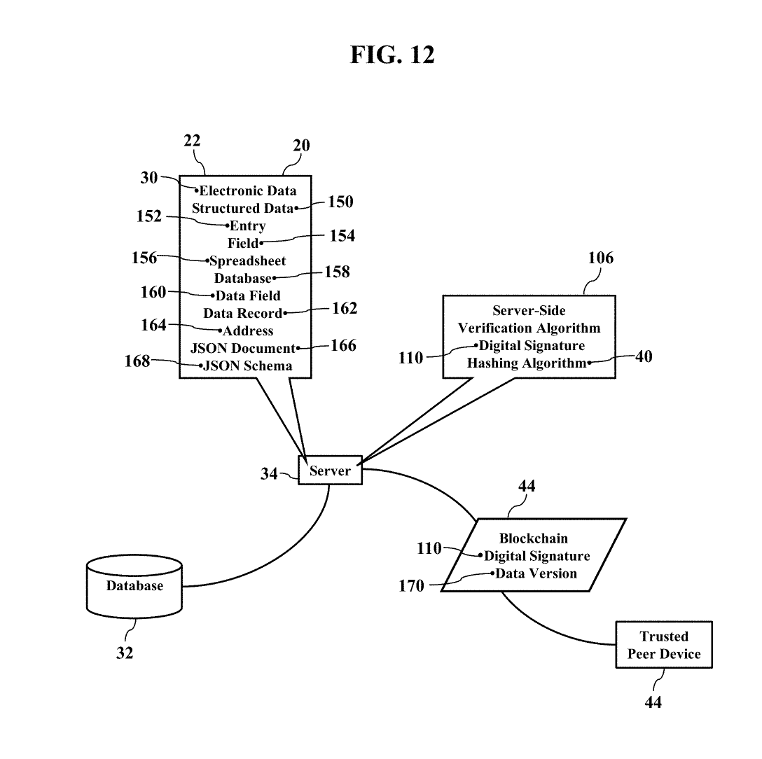

FIG. 12 illustrates structured data 150. As the reader may understand, the electronic data 30 representing the electronic document 20 may be the structured data 150. That is, the structured data 150 may be organized (such as an entry 152 or database field 154 in a relational spreadsheet 156 or database 158), contained within a fixed data field 160 or data record 162, and/or be addressable via a network or memory address 164. Again referencing the loan application 22, the structured data 150 may be organized according to the JavaScript Object Notation (or “JSON”). As the JavaScript Object Notation is a known format for structuring data, the JSON format need not be explained in detail. Suffice it to say that at least some of the electronic data 30 representing the electronic document 20 (or the entire loan application 22) may be a JSON document 166 having the structured data 150 arranged as fields, formatted according to a JSON schema 168, and perhaps stored in the electronic database 32.

Exemplary embodiment may thus incorporate a data version 170 in the blockchain 42. For example, if the electronic document 20 is the JSON document 166, then the data version 170 may be the structured data 150 arranged or formatted according to the JSON schema 168. Exemplary embodiments may thus retrieve the data version 170 and generate the corresponding digital signature 110 (such as the 256-bit hash value using the SHA-256 hashing algorithm 40). Exemplary embodiments may then incorporate the digital signature 110 into the blockchain 42 for distribution (such as to the trusted peer device 44). The trusted peer device 44 may thus verify an alleged copy of the electronic document 20 against the blockchain 42 (as this disclosure above explains). Moreover, once the structured data 150 is known (such as JSON schema 168), any electronic document referenced in the electronic database 32 may be recreated, hashed, and checked against the blockchain 42 to ensure the electronic data 30 has not been altered. For example, if the electronic data 30 representing the electronic document 20 is stored in a banking server, then exemplary embodiments permit recreating the electronic document 20 (perhaps via a POSGRES® database) and authentication.

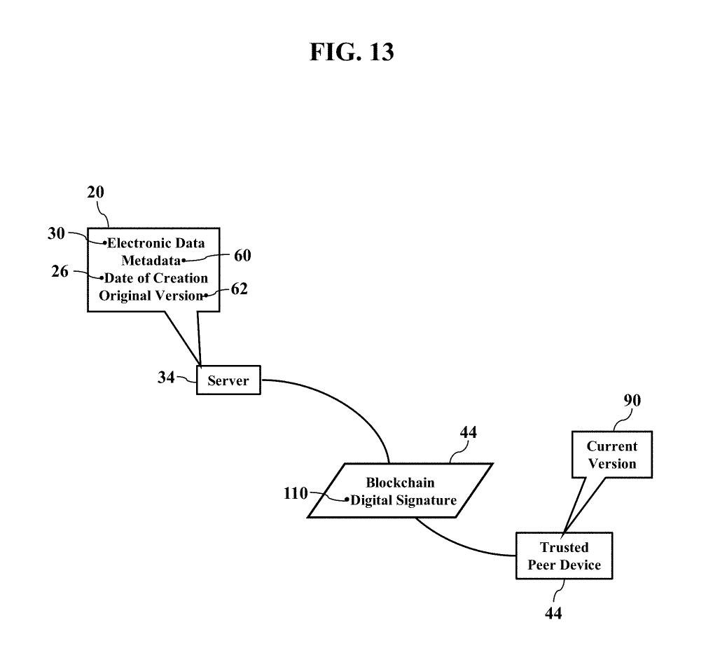

FIG. 13 illustrates metadata 60. Here the electronic data 30 representing the electronic document 20 may include the metadata 60 (such as [{“CreationTime”:“2012-05-07T11:12:32”}, {“SourceID”: “1131122”}, {“Location”: “Wells Fargo System XXX, ID YYY”} . . . ]. Exemplary embodiments may thus retrieve the metadata 60 and generate the corresponding digital signature 110 (such as the 256-bit hash value representing the metadata 60). Exemplary embodiments may then incorporate the digital signature 110 representing the metadata 60 into the blockchain 42 for distribution to the trusted peer device 44. The trusted peer device 44 may thus perform a two-fold verification. That is, any alteration to the electronic document 20 may be determined (as this disclosure explains), but exemplary embodiments may also verify that the date of creation 26 (e.g., [{“CreationTime”:“2012-05-07T11:12:32”}] has not changed. Again, if the digital signature 110 representing the metadata 60 has changed over time (such as when comparing the original version 62 to the current version 90), then exemplary embodiments may flag or notify of a possible fraud attempt. Any change in the digital signature 110 over time may also be useful for audit trails in banking, mortgage processing, and other activities.

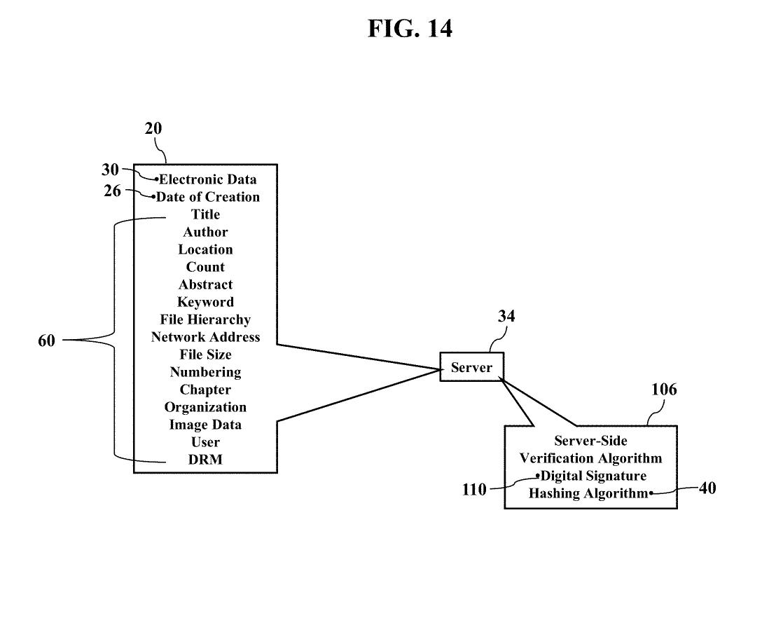

FIG. 14 illustrates different types of the metadata 60. While exemplary embodiments may hash any type of the metadata 60, this disclosure will mainly describe the metadata 60 thought familiar to most readers. For example, the metadata 60 may describe the date and time of the creation 26, the filename, the title, an author, the location (such as GPS information at creation 26), word/character count, and an abstract describing or summarizing the electronic document 20. The metadata 60 may also include one or more keywords associated with the electronic document 20. The metadata 60 may also include a file hierarchy where the electronic document 20 is stored and/or the network address or URL for retrieval. The network address, for example, may be associated with a server or other machine locally or remotely storing the electronic document 20. The metadata 60 may also include structural details, such as file size, the page number, chapter organization, and image data. Other metadata 60 may describe approved users (such as administrator and user permissions or identities) and digital rights management (or “DRM”). The metadata 60 may be formatted according to any standard. The PDF data, the metadata 60, and/or the data version 170 may also be retrieved and recreated for verification.

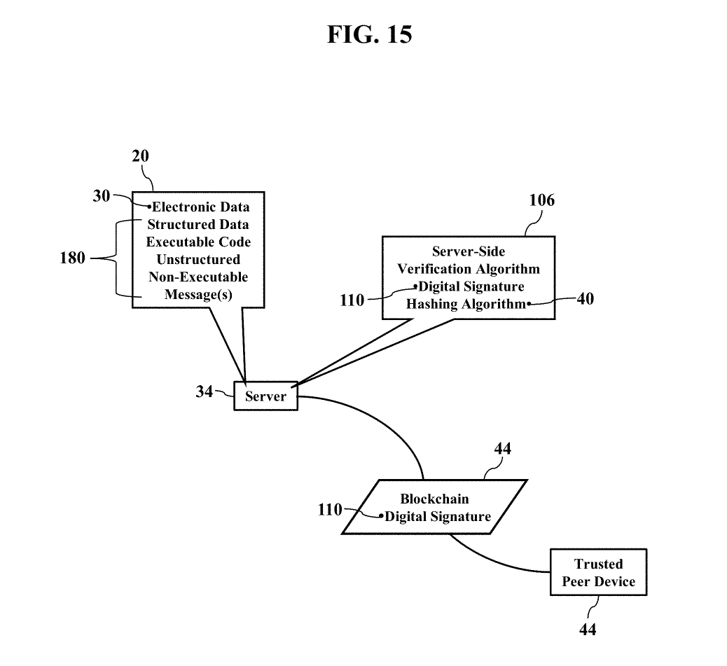

FIG. 15 illustrates instructions 180. Here the electronic data 30 may include the instructions 180. While exemplary embodiments may be applicable to any instructions, the instructions 180 may be structured (such as executable code), unstructured instructions (such as non-executable commentary lines in code, such as English language “do thing 1, then thing 2, then thing 3”). Other instructions 180 may include any messages (such as “When this document is accessed, POST to the URL http://some.target.url”). Exemplary embodiments may thus retrieve the instructions 180, generate the corresponding digital signature 110 (such as the 256-bit hash value representing the instructions 180), and incorporate into the blockchain 42. Again, if the digital signature 110 representing the instructions 180 has changed over time, then exemplary embodiments may flag or notify of a possible fraud attempt.

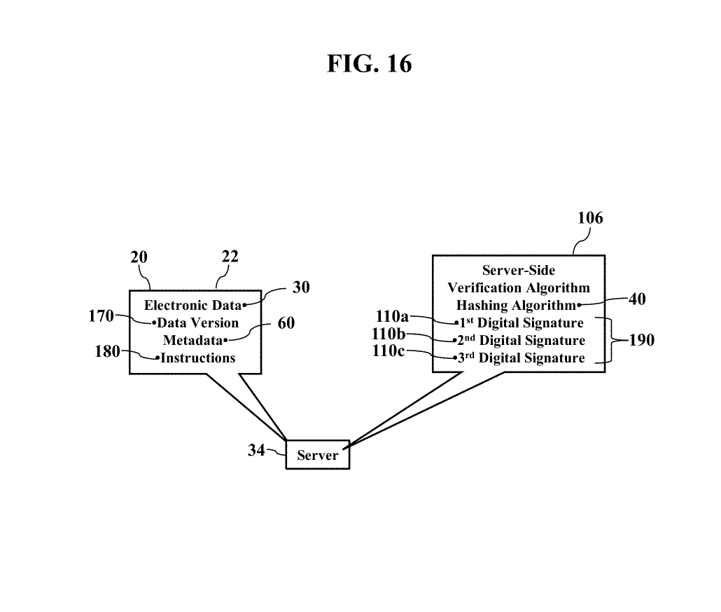

FIG. 16 illustrates multiple digital signatures 190, according to exemplary embodiments. Because the electronic document 20 may comprise or contain multiple types of the electronic data 30, exemplary embodiments may generate the multiple digital signatures 190. Exemplary embodiments, for example, may generate a first digital signature 110a (such as the 256-bit hash value using the SHA-256 hashing algorithm 40) based on the data version 170 associated with the electronic document 20 (as above explained with reference to FIG. 12). Exemplary embodiments may generate a second digital signature 110b based on the metadata 60 contained within, or associated with, the electronic document 20 (as above explained with reference to FIGS. 13-14). Exemplary embodiments may generate a third digital signature 110c based on the instructions 180 contained within, or associated with, the electronic document 20 (as above explained with reference to FIG. 15). Any or all of the multiple digital signatures 190 may be generated based on the electronic data 30 representing the individual electronic document 20 and/or the entire loan application 22.

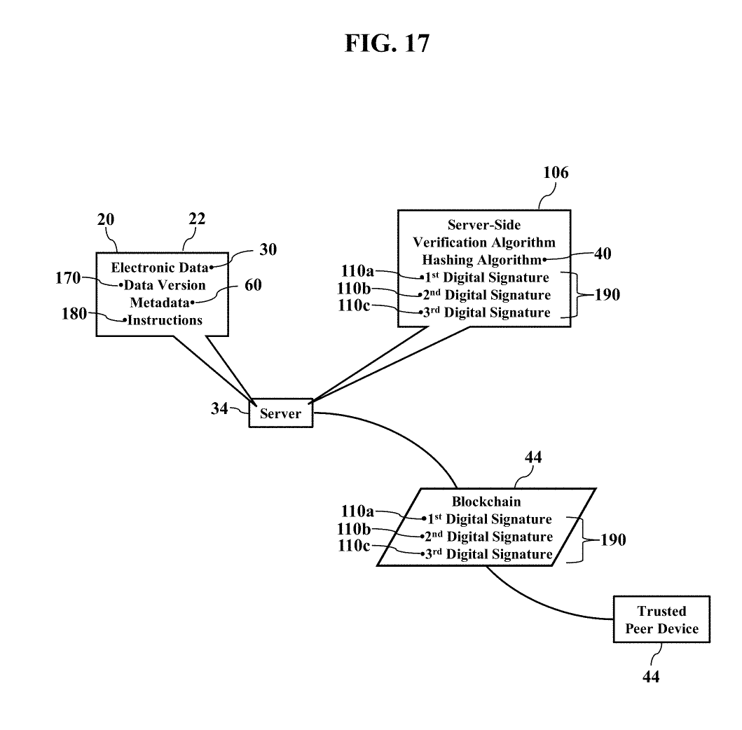

FIG. 17 further illustrates the blockchain 42, according to exemplary embodiments. Once any of the multiple digital signatures 190 is/are generated, exemplary embodiments may incorporate one or more of the multiple digital signatures 190 into the blockchain 42. That is, any one or more of the multiple digital signatures 190 may be added to, stored in, or incorporated into any record, transaction, or block within the blockchain 42. FIG. 17, for simplicity, illustrates the blockchain 42 including the first digital signature 110a (based on the data version 170), the second digital signature 110b (based on the metadata 60), and the third digital signature 110c (based on the instructions 180). The server 34 may then distribute or broadcast the blockchain 42 to the trusted peer device 44 for subsequent verification.

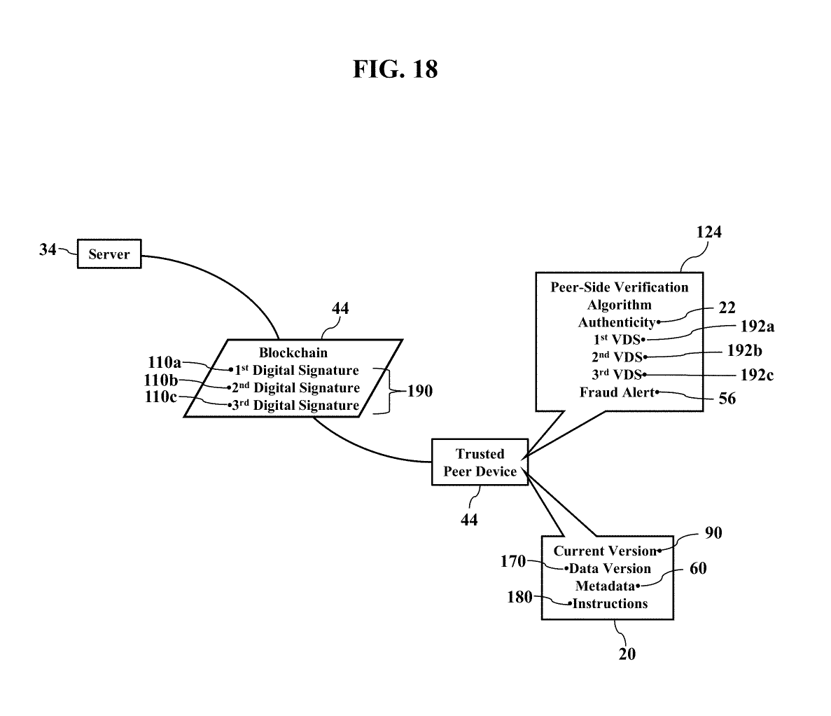

FIG. 18 illustrates multiple verifications, according to exemplary embodiments. Once any of the multiple digital signatures 190 (e.g., 110a, 110b, and/or 110c) are received (perhaps via the blockchain 42), the trusted peer device 44 may then use any one or more of the multiple digital signatures 190 to verify the authenticity of the current version 90 of the electronic document 20. The peer-side verification algorithm 124, for example, may cause the trusted peer device 44 to generate a first verification digital signature (“1^{st} VDS”) 192a by hashing the data version 170 associated with the current version 90. The peer-side verification algorithm 124 additionally or alternatively cause the trusted peer device 44 to generate a second verification digital signature (“2^{nd} VDS”) 192b by hashing the metadata 60 associated with the current version 90. The peer-side verification algorithm 124 additionally or alternatively cause the trusted peer device 44 to generate a third verification digital signature (“3^{rd} VDS”) 192b by hashing the instructions 180 associated with the current version 90. If any one or more of the verification digital signatures 192a, 192b, and/or 192c satisfactorily compares to their corresponding digital signatures 110a, 110b, and/or 110c, then the peer-side verification algorithm 124 may infer or determine that the current version 90 is authentic and unaltered. However, if any one or more of the verification digital signatures 192a, 192b, and/or 192c fails to match or satisfy their corresponding digital signatures 110a, 110b, and/or 110c, then the peer-side verification algorithm 124 may infer that the current version 90 is inauthentic and altered. The peer-side verification algorithm 124 may thus generate the fraud alert 56 to implement enhanced security measures.

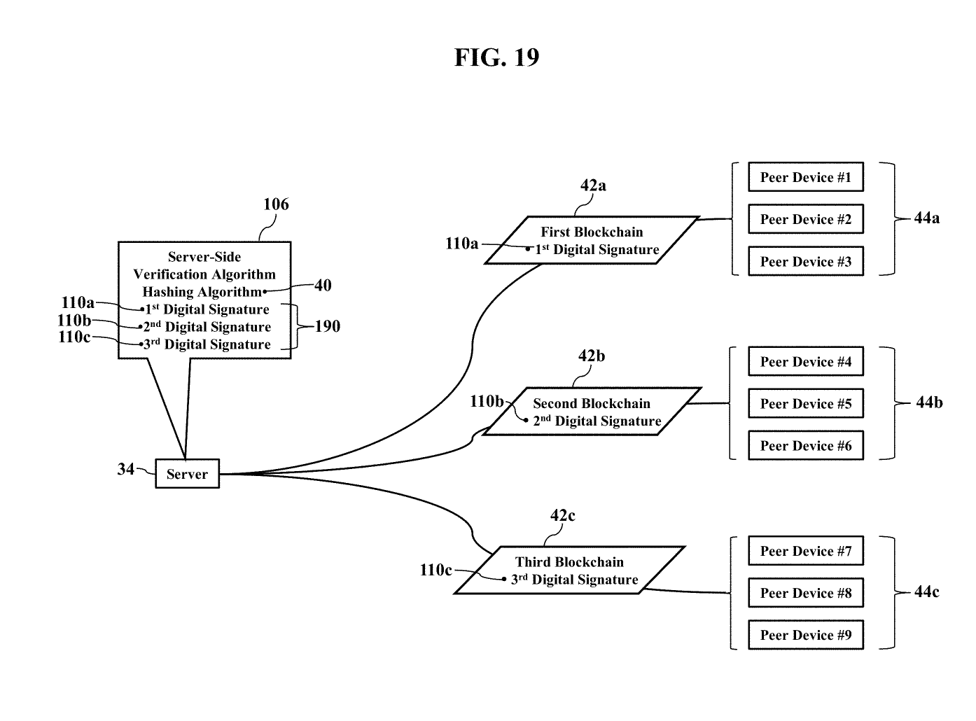

FIG. 19 illustrates multiple blockchains 42, according to exemplary embodiments. Here the server 34 may integrate any one or more of the multiple digital signatures 190 (e.g., 110a, 110b, and/or 110c) into multiple blockchains 42. While exemplary embodiments may utilize any number of different blockchains 42, FIG. 19 illustrates a simple example of three (3) different blockchains 42a-c. The first digital signature 110a (generated by hashing the data version 170 associated with the electronic document 20, as illustrated with reference to FIGS. 16-17) may be integrated into a first blockchain 42a. The second digital signature 110b (generated by hashing the metadata 60, as illustrated with reference to FIGS. 16-17) may be integrated into and distributed via a second blockchain 42b. The third digital signature 110c (based on hashing the instructions 180, as illustrated with reference to FIGS. 16-17) may be integrated into and distributed via a third blockchain 42c. The multiple blockchains 42a, 42b, and 42c may be broadcast to the same group of peer devices or separately sent to different groups or destinations. The different digital signatures 110a-c, in other words, may be distributed via the different blockchains 42a-c to different peer devices.

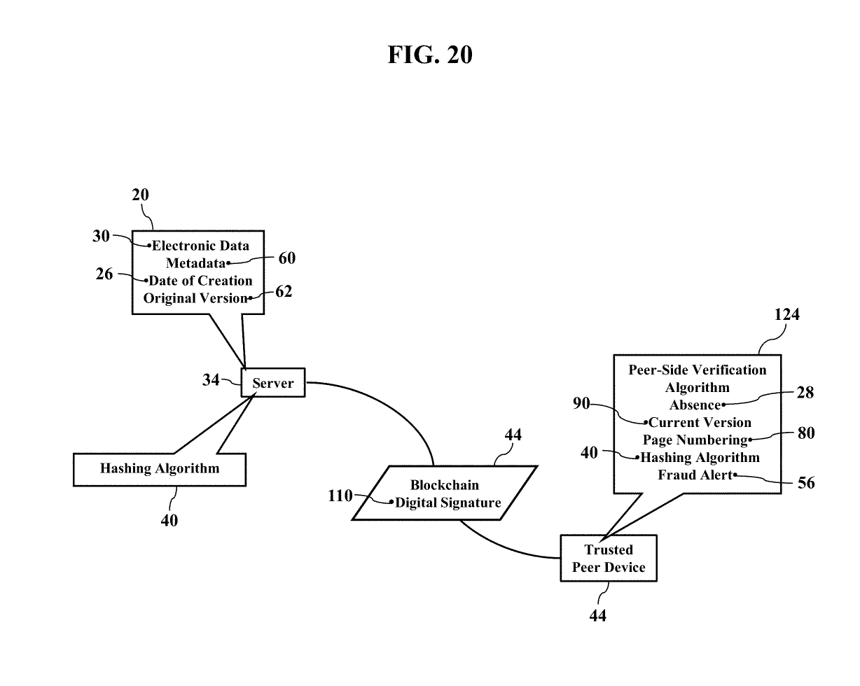

FIGS. 20-22 further illustrate verification of the absence 28, according to exemplary embodiments. Here the digital signature 110 may permit verifying when a particular document is absent from the current version 90 of the loan application 22. Suppose the metadata 60 includes data or information describing the page numbering 80 within the electronic document 20. As a simple example, suppose the metadata 60 specifies that pages 1-50 are present in the original version 62 of the electronic document 20 at the date/time of creation 26. The metadata 60 specifying these fifty pages may be hashed using the hashing algorithm 40 and distributed via the blockchain 44. When the trusted peer device 44 retrieves the current version 90 of the electronic document 20, the trusted peer device 44 may verify whether the fifty (50) pages are still present. That is, the trusted peer device 44 hashes the metadata 60 associated with the current version 90 and compares to the blockchain 44. If a match is determined, then all fifty (50) pages are still present in the original version 62. However, if the hashed metadata 60 fails to match the blockchain 44, then the metadata 60 has changed. The number 80 of pages, in other words, may have changed, perhaps indicating a page has been deleted or removed from the current version 90 of the loan application 22. Exemplary embodiments may thus initiate the fraud alert 56.

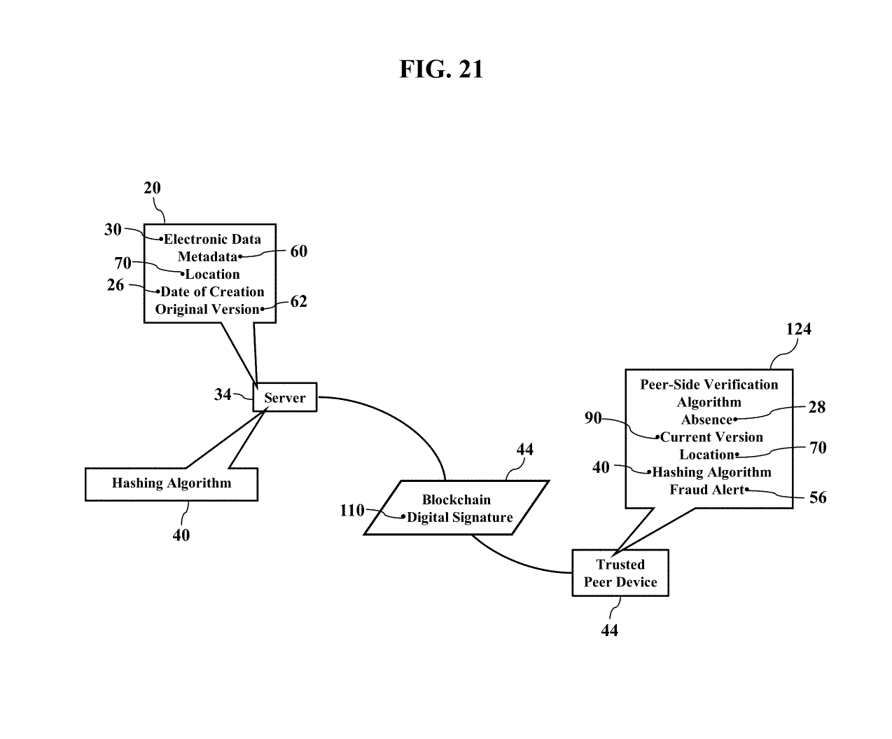

FIG. 21 illustrates locational verification. Here exemplary embodiments may verify the location 70 associated with the electronic document 20. Recall that the metadata 60 may describe or specify the geographical location (such as global positioning system coordinates 72) and/or the logical location (such as a uniform resource locator (or URL”) 74, a network address 76, a memory pointer 78, or even the page number 80 within the loan application 22) associated with the electronic document 20 (as illustrated with reference to FIGS. 4-5 & 14). Exemplary embodiments may hash the location 70 and distribute via the blockchain 44. When the trusted peer device 44 retrieves the current version 90 of the electronic document 20, the trusted peer device 44 may verify whether the same location 70 is still present. That is, the trusted peer device 44 hashes the location 70 associated with the current version 90 and compares to the blockchain 44. If a match is determined, then the location 70 is confirmed. However, if the hashed metadata 60 fails to match the blockchain 44, then the location 70 has changed and the fraud alert 56 may be initiated.

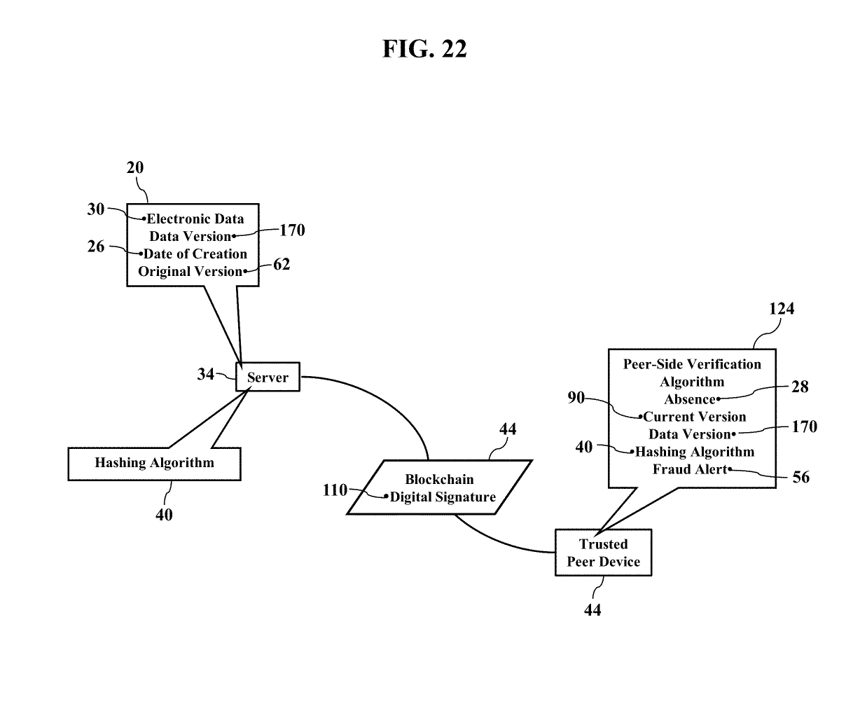

FIG. 22 illustrates versional verification. Here exemplary embodiments may verify the data version 170 associated with the electronic document 20. Recall that the data version 170 may describe or specify a version number or other identifier associated with the electronic document 20 (as illustrated with reference to FIGS. 12 & 19). Exemplary embodiments may hash the data version 170 and distribute via the blockchain 44. When the trusted peer device 44 retrieves the current version 90 of the electronic document 20, the trusted peer device 44 may verify whether the same data version 170 is still present. That is, the trusted peer device 44 hashes the data version 170 associated with the current version 90 and compares to the blockchain 44. If a match is determined, then the data version 170 is confirmed. However, if the hashed metadata 60 fails to match the blockchain 44, then the data version 170 has changed and the fraud alert 56 may be initiated.

Exemplary embodiments may thus verify the absence 28 of the electronic data 30 contained within the current version 90 of the electronic document 20. Separately hashing and/or distributing different data types allows quick verification of alterations. The digital signature 110 integrated within the blockchain 44 may specify that a particular data version 170 of the electronic document 20 is retrievable from the location 70 (e.g., network address, URL, or internal pointer). If the current version 90 of the electronic document 20 cannot produce the same digital signature 110, then exemplary embodiments may flag the fraud alert 56. The blockchain 44, for example, may specify (via hashing) that “Version XXX of Document YYY is located at ZZZ.” If the current version 90 of the electronic data 30 cannot produce the same hash value, then the original version 62 of the electronic document 20 may no longer exist at the same location 70. Foul play may be afoot.

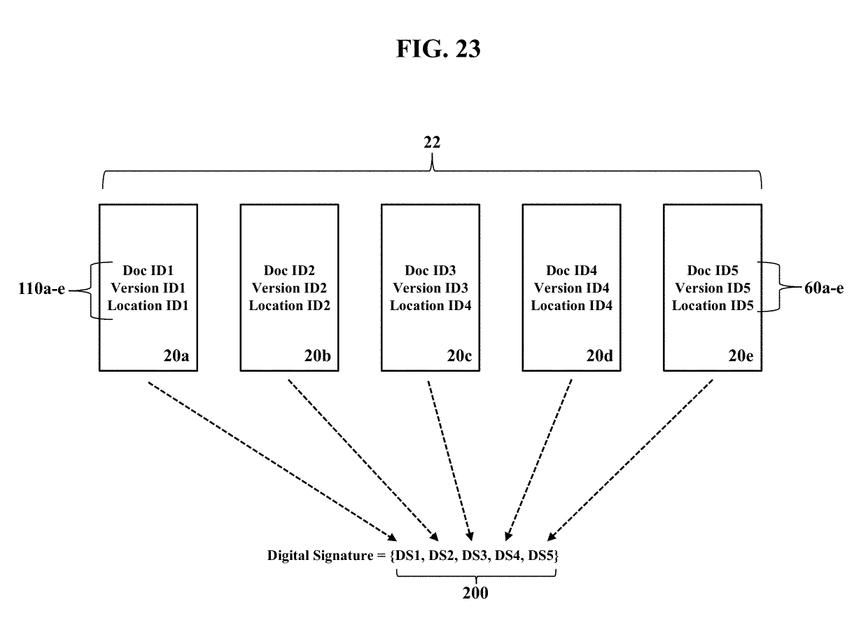

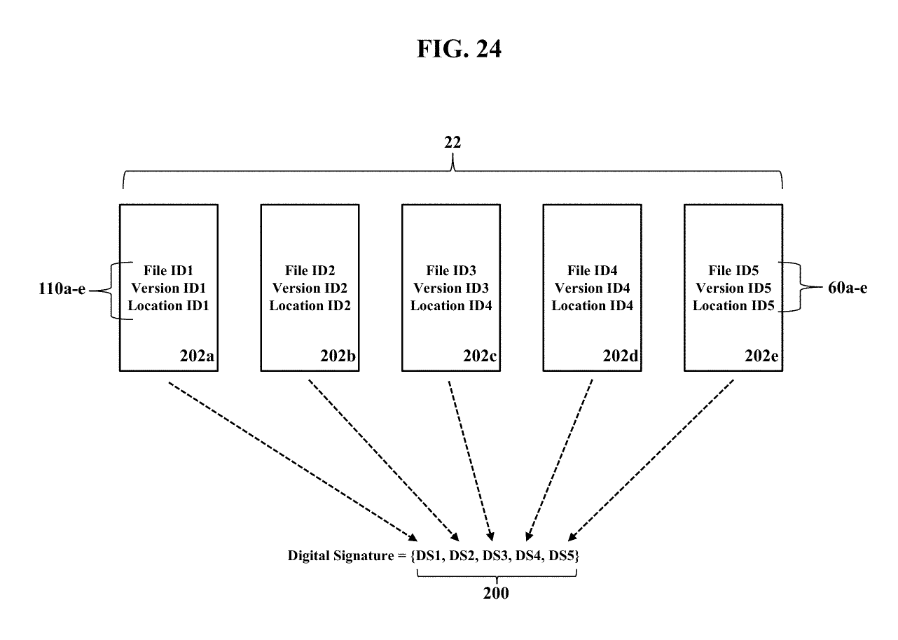

FIGS. 23-24 illustrate sequential verification, according to exemplary embodiments. Here exemplary embodiments may generate a series listing 200 of the digital signatures 110 representing the loan application 22. That is, each different electronic document 20 within the loan application 22 may be represented as a sequence of the digital signatures 110. As the reader may understand, the loan application 22 may contain many or even hundreds of different documents. For simplicity, though, FIG. 23 only illustrates five (5) different electronic documents 20a-e. Each document 20a-e is associated with its corresponding metadata 60 describing its document identifier, data version 170, and location 70. Exemplary embodiments may hash each document's metadata 60a-e to generate the corresponding digital signature 110a-e. Exemplary embodiments may then assemble or package the multiple digital signatures 110a-e as the series listing 200 ({DS1, DS2, DS3, DS4, DS5}). The series listing 200 may then be distributed via the blockchain 44 (as this disclosure above explains). The trusted peer device 44 may then verify the series listing 200 at some later time. That is, the trusted peer device 44 retrieves the current version 90 of the loan application 22 and generates the digital signatures representing the current electronic documents. If a match is determined, then the current version 90 of the loan application 22 contains the same series of the metadata 60 (e.g., document identifier, data version 170, and location 70). However, if the two series listings 200 fail to match, then the current version 90 of the loan application 22 contains different documents and/or a different arrangement, thus justifying the fraud alert 56. Indeed, a series comparison between the entries representing the original version 62 and the current version 90 would reveal a missing document and/or a changed document.

FIG. 24 further illustrate sequential verification. Here the loan application 22 may be composed of separate electronic files 202a-c. Again, the reader should understand that the loan application 22 may contain many or even hundreds of different files 202. The individual files 202 may then be retrieved and assembled as the entire loan application 22. For simplicity, though, FIG. 24 only illustrates five (5) different electronic files 202a-c. Exemplary embodiments may thus generate the series listing 200 of the digital signatures 110 representing the electronic files 202a-c. Each electronic file 202a-c is associated with its corresponding metadata 60 describing its filename or other identifier, data version 170, and location 70. Exemplary embodiments may hash each file's metadata 60a-e to generate the corresponding digital signature 110a-e. Exemplary embodiments may then assemble or package the multiple digital signatures 110a-e as the series listing 200 ({DS1, DS2, DS3, DS4, DS5}). The series listing 200 may then be distributed via the blockchain 44 (as this disclosure above explains). The trusted peer device 44 may then verify the series listing 200 at some later time. That is, the trusted peer device 44 retrieves the current version 90 of the loan application 22 and generates the digital signatures representing the current electronic files. If a match is determined, then the current version 90 of the loan application 22 contains the same series of the metadata 60 (e.g., file identifier, data version 170, and location 70). However, if the two series listings 200 fail to match, then the current version 90 of the loan application 22 contains different files and/or a different arrangement, thus justifying the fraud alert 56. Indeed, a series comparison between the entries representing the original version 62 and the current version 90 would reveal a missing and/or a changed file.

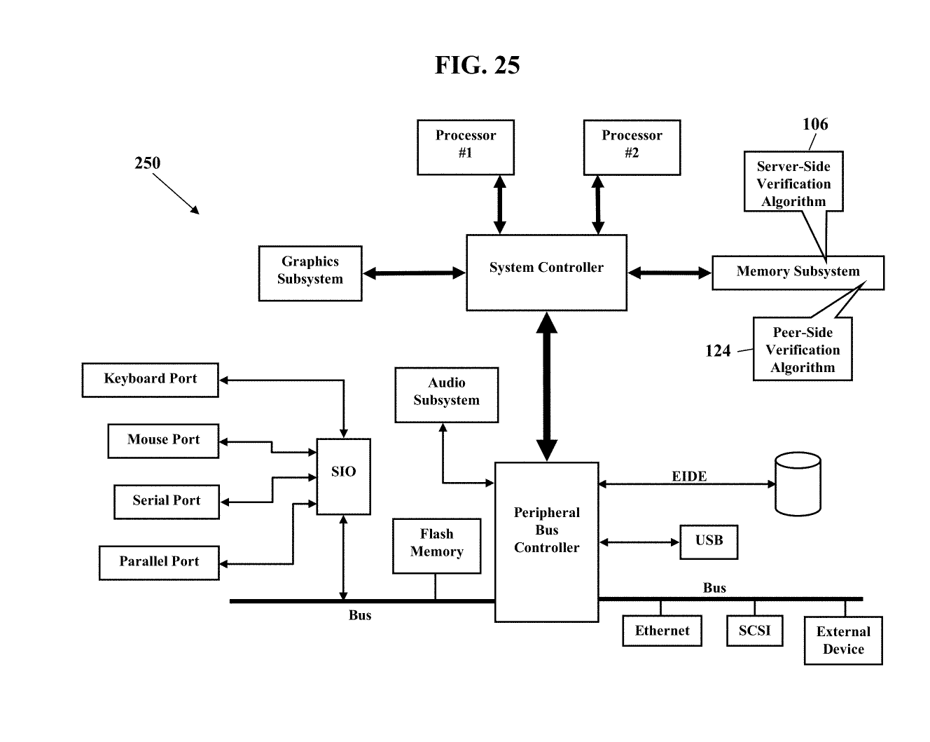

FIG. 25 is a schematic illustrating still more exemplary embodiments. FIG. 25 is a more detailed diagram illustrating a processor-controlled device 250. As earlier paragraphs explained, the server-side verification algorithm 106 and the peer-side verification algorithm 124 may partially or entirely operate in any mobile or stationary processor-controlled device. FIG. 25, then, illustrates the server-side verification algorithm 106 and the peer-side verification algorithm 124 stored in a memory subsystem of the processor-controlled device 250. One or more processors communicate with the memory subsystem and execute either, some, or all applications. Because the processor-controlled device 250 is well known to those of ordinary skill in the art, no further explanation is needed.

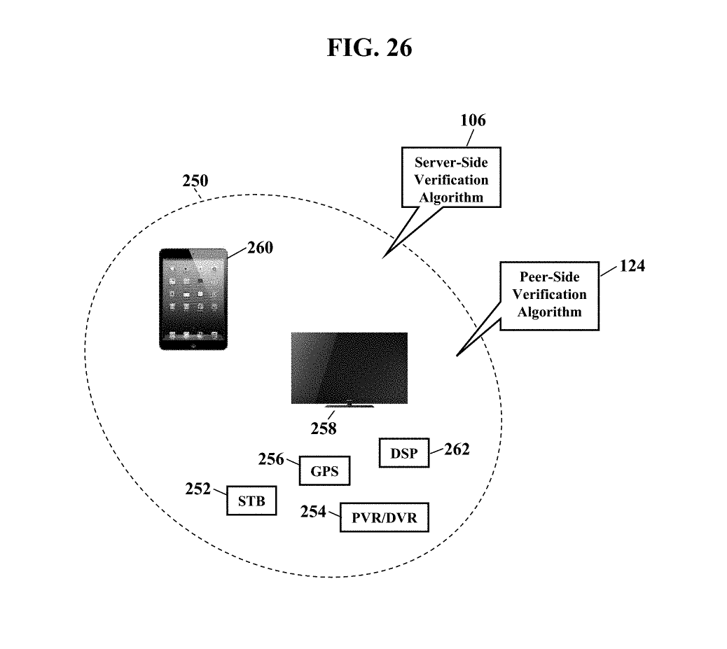

FIG. 26 depicts other possible operating environments for additional aspects of the exemplary embodiments. FIG. 26 illustrates the server-side verification algorithm 106 and the peer-side verification algorithm 124 operating within various other processor-controlled devices 250. FIG. 26, for example, illustrates that the server-side verification algorithm 106 and the peer-side verification algorithm 124 may entirely or partially operate within a set-top box (“STB”) (252), a personal/digital video recorder (PVR/DVR) 254, a Global Positioning System (GPS) device 256, an interactive television 258, a tablet computer 260, or any computer system, communications device, or processor-controlled device utilizing any of the processors above described and/or a digital signal processor (DP/DSP) 262. Moreover, the processor-controlled device 250 may also include wearable devices (such as watches), radios, vehicle electronics, clocks, printers, gateways, mobile/implantable medical devices, and other apparatuses and systems. Because the architecture and operating principles of the various devices 250 are well known, the hardware and software componentry of the various devices 250 are not further shown and described.

Exemplary embodiments may be applied to any signaling standard. Most readers are thought familiar with the Global System for Mobile (GSM) communications signaling standard. Those of ordinary skill in the art, however, also recognize that exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard. Exemplary embodiments may also be applied to other standards, such as the I.E.E.E. 802 family of standards, the Industrial, Scientific, and Medical band of the electromagnetic spectrum, BLUETOOTH®, and any other.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for sharing secrets via blockchains, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method of verifying an electronic mortgage application, the method comprising:
retrieving, by a server, metadata associated with the electronic mortgage application;
generating, by the server, a digital signature in response to hashing the metadata using an electronic representation of a hash function;
retrieving, by the server, a hash value distributed via a blockchain;
comparing, by the server, the digital signature generated by the hashing of the metadata to the hash value distributed via the blockchain;
determining, by the server, that the electronic mortgage application is authentic in response to the digital signature generated by the hashing of the metadata matching the hash value distributed via the blockchain; and
determining, by the server, that the electronic mortgage application is inauthentic in response to the digital signature generated by the hashing of the metadata failing to match the hash value distributed via the blockchain.

2. The method of claim 1, further comprising generating a second digital signature based on hashing structured data associated with the electronic mortgage application.

3. The method of claim 2, further comprising determining that the electronic mortgage application is the inauthentic in response to the second digital signature failing to match the hash value distributed via the blockchain.

4. The method of claim 1, further comprising determining an absence associated with the electronic mortgage application.

5. The method of claim 1, further comprising determining a document is missing from the electronic mortgage application based on the digital signature failing to match the hash value distributed via the blockchain.

6. The method of claim 1, further comprising determining a memory mislocation associated with the electronic mortgage application based on the digital signature failing to match the hash value distributed via the blockchain.

7. The method of claim 1, further comprising determining a change to the electronic mortgage application based on the digital signature failing to match the hash value distributed via the blockchain.

8. A system, comprising:
a hardware processor; and
a memory device, the memory device storing instructions, the instructions when executed causing the hardware processor to perform operations, the operations comprising:
retrieving metadata associated with an electronic mortgage application;
generating a digital signature in response to hashing the metadata using an electronic representation of a hash function;
retrieving a hash value distributed via a blockchain;
comparing the digital signature to the hash value distributed via the blockchain;
determining that the electronic mortgage application is authentic in response to the digital signature matching the hash value distributed via the blockchain; and
determining that the electronic mortgage application is inauthentic in response to the digital signature failing to match the hash value distributed via the blockchain.

9. The system of claim 8, wherein the operations further comprise generating a fraud alert in response to the digital signature failing to match the hash value distributed via the blockchain.

10. The system of claim 8, wherein the operations further comprise generating a second digital signature based on hashing structured data associated with the electronic mortgage application.

11. The system of claim 10, wherein the operations further comprise determining that the electronic mortgage application is the inauthentic in response to the second digital signature failing to match the hash value distributed via the blockchain.

12. The system of claim 8, wherein the operations further comprise determining an absence associated with the electronic mortgage application.

13. The system of claim 8, wherein the operations further comprise determining a document is missing from the electronic mortgage application based on the digital signature failing to match the hash value distributed via the blockchain.

14. The system of claim 8, wherein the operations further comprise determining a memory mislocation associated with the electronic mortgage application based on the digital signature failing to match the hash value distributed via the blockchain.

15. The system of claim 8, wherein the operations further comprise determining a change to the electronic mortgage application based on the digital signature failing to match the hash value distributed via the blockchain.

16. A memory device storing instructions that when executed cause a hardware processor to perform operations, the operations comprising:
retrieving electronic data associated with an electronic mortgage application;
generating multiple digital signatures in response to hashing the electronic data using an electronic representation of a hash function, a first digital signature of the multiple digital signatures generated in response to the hashing of a data version associated with the electronic mortgage application, a second digital signature of the multiple digital signatures generated in response to the hashing of metadata associated with the electronic mortgage application, and a third digital signature of the multiple digital signatures generated in response to the hashing of instructions associated with the electronic mortgage application;
retrieving multiple hash values distributed via a blockchain;
comparing the multiple digital signatures to the multiple hash values distributed via the blockchain;
determining that the electronic mortgage application is authentic in response to all the multiple digital signatures matching the multiple hash values distributed via the blockchain; and
determining that the electronic mortgage application is inauthentic in response to any one of the multiple digital signatures failing to match any one of the multiple hash values distributed via the blockchain.

17. The memory device of claim 16, wherein the operations further comprise generating a fraud alert in response to the determining that the electronic mortgage application is the inauthentic.

18. The memory device of claim 16, wherein the operations further comprise generating a fraud alert in response to the failing of the match between the any one of the multiple digital signatures and the any one of the multiple hash values distributed via the blockchain.

19. The memory device of claim 16, wherein the operations further comprise determining a document is missing from the electronic mortgage application based on the hashing of metadata.

20. The system of claim 8, wherein the operations further comprise determining a memory mislocation associated with the electronic mortgage application based on the hashing of metadata.
